(19) United States
(12) Patent Application Publication
(10) Pub. No.: US 2017/0337761 A1
(43) Pub. Date: Nov. 23, 2017

(54) Live Concert Music Voting System

(71) Applicant: Jordan Kyle Dunnington, Grapevine, TX (US)

(72) Inventor: Jordan Kyle Dunnington, Grapevine, TX (US)

(21) Appl. No.: 15/584,295

(22) Filed: May 2, 2017

Related U.S. Application Data
(60) Provisional application No. 62/337,477, filed on May 17, 2016.

(51) Int. Cl. G07C 13/00; G06Q 30/02; G06Q 50/00; H04W 4/00; H04L 29/08

(52) U.S. Cl. CPC G07C 13/00; G06Q 50/01; H04W 4/008; G06Q 30/0201; H04L 67/306; H04L 67/22

(57) ABSTRACT

An in-concert music voting system, a user is associated with a concert and an artist uploads song selections for a concert performance. The system communicates a real-time setlist result to users of the system prior to or during a concert performance. The user logs in and joins a waiting room to vote. The artist starts the voting period. Users can access the “Pulse” and “Flow” tabs, where they will vote on the setlist or song and be updated live on the voting progress. Options for social engagement will be provided. The system tabulates votes and determines a winning song or setlist. The artist performs the song or setlist. Users receive participation awards.

### BACKGROUND OF THE INVENTION

### 1. Field of Invention

The present invention relates to the field of real-time voting for music in a live music scenario.

### 2. Description of Related Art

In the prior art, fans can vote on music through purchases (basically, the more highly rated the music, the more likely it becomes for people to view advertising for or purchase the music. it, This may generally occur in connection with media streaming services such as YouTube™. Users may also vote on music in American Idol, for example, wherein the votes are tabulated and determine the winner of a particular episode.

However, these views and votes are not tabulated and made available in real-time, in that a viewer cannot see the current number of purchases or the ranking that results therefrom, and are therefore not available for a performer of live music, at the time of the performance, to determine audience input on song choices or setlist.

An example of a real-time system for vote compilation is the ‘Trending’ concept on Twitter™, or the live artist voting in “The Voice”™ in 2016. However, such are not useful for tabulating votes on music in a real-time environment, such that it may be used by an artist within a concert setting. In some embodiments, artists have what are known as “audibles:” songs that they may or may not be played during the concert depending on whether the artists believes they will be appreciated by the audience.

Based on the foregoing, there is a need in the art for a real-time vote-tabulation system that provides feedback to a performer on the audience's preferences and song choice for a live concert.

### SUMMARY

An in-concert music voting system has a user inputting information on music preferences, a user inputting a playlist for sharing with other users, a user scanning through the playlist and swiping to vote for or against each musical selection, the musical selections being matched against music preferences for a user, once a match is made, the user becoming in a sharing relationship with one or more other users with similar preferences, and users creating playlists and sharing them with the other users.

In an embodiment, the user swipes right to vote for the selection, and swipes left to vote against the selection, and in another embodiment, the user swipes left to vote for the selection, and swipes right to vote against the selection. The music preferences may be selected from the list consisting of music genres, subgenres, artists and album. The system may also have the additional step of further comprising the step of the user engaging in a jam session with the other users, and/or of assigning a tag to the user profile so that users may share the system with other connections. Parties may advertise and push ads or boost posts to specific target audiences.

In another embodiment, an in-concert music voting system with a user is associated with a concert. In connection with an artist uploading song selections for a concert, the user logs in and joins a waiting room. The user is able to vote on artist's setlist in advance. If the user votes, the user is presented with a “Flow” tab. If the user does not vote, an option is presented to the user to click on the “Flow” tab. The user is restricted to voting on a selection related to a particular feed. One or more votes are communicated to the artist and voting progress is continually monitored by the system with the progress being provided to the user. The user receives notification of a winning song for placement on the setlist, in connection with communicating a real-time setlist to all the user's systems. The artist performs the songs on the setlist, receiving votes continually during the concert. Votes are tabulated to produce a winning song result.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1 is a flowchart view of the system, according to an embodiment of the present invention.

### DETAILED DESCRIPTION OF PREFERRED EMBODIMENTS

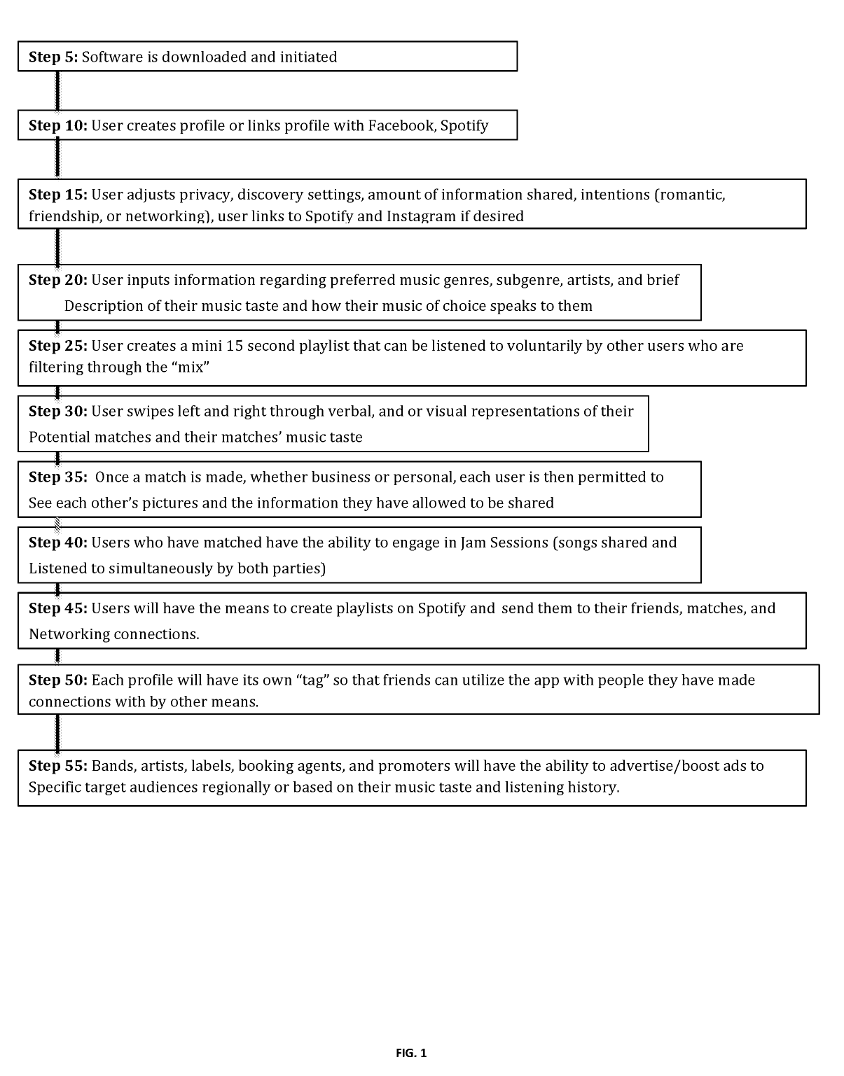

Preferred embodiments of the present invention and their advantages may be understood by referring to FIG. 1, wherein like reference numerals refer to like elements.

In step 5, the system is loaded onto a portable device such as a smartphone, that permits input from the user through a screen and/or keys, and communicates with one or more wireless networks. In step 10, the user logs into the system, which uniquely identifies the user and provides the user with a profile and a usage history. In step 15, the user is associated with a concert through stored or entered preferences or through a GPS location. A voting session for a particular event, referenced herein as a concert feature when the event is a concert, then begins prior to the concert with one or more setlists being uploaded by an artist. In step 17, the artist uploads song or playlist selections. In step 18, users login to the concert feature and join a waiting room, where the user waits until a voting phase is open. For voting during live concerts, all voters vote during the same time period as defined by a pre-concert window of time (voting period). For voting before live concerts (e.g., fans voting on an uploaded playlist), users may respond to a push notification from the app for when the voting period begins and another 5 minutes before it ends. The artist has the flexibility to set the duration of the pre-concert window of time, i.e., the voting period.

The system may remember a password and allow a simple swipe or click to effect a login, or may use a fingerprint to authenticate the user. For example in some streaming music apps like Apple Music or Spotify, the login will be tied to the unique profile, and the system may use this third-party authentication. In step 20, the voting phase is open and users are taken to the “Pulse” tab, where using the pulse and flow tabs, users vote on setlists in advance, track progress of their voting and, optionally, the votes of a collective group of users. In step 21, a voting user is presented with a “Flow” tab where the user may contribute to conversations or chat about song choices, persuade undecided voters to vote for a selection, etc.

Non-viewers or users who aren't attending will not be able to influence the setlists of a live concert, as the system is intended for the benefit of live-concert viewers. The system provides a live-event, location-based “check-in” system. Votes will be tallied through a “Live Ticket”, which would be something offered through Ticketmaster™ and would apply to the part of a concert/live event (e.g. “Live Experience”) where artists allow crowds to weigh in on setlists or songs. A concert-goer would have the option to buy different levels of Live Tickets called “Stages”. Each type of Live Ticket would offer a combination of a stronger vote and/or better participation rewards. For example, one scheme may provide the following: i) Stage 1, Live Ticket—each vote is normal weighted & participation rewards are normal; ii) Stage 2, Live Ticket—Vote is normally weighted & users are more likely to obtain better participation rewards; and iii) Stage 3, Live Ticket-Votes are weighted 2× as much & users are more likely to obtain the best participation rewards. In one embodiment, users may save, share, or resale tickets with other users and /or friends. There may be an optional feature for special live events (e.g. The Grammys™) where all of those who are either checked in at the event or have a special event TV Live Ticket (ex. Grammy Live Ticket) may vote, and in these special occasions, weighted voting may be chosen (for instance, for the Grammys™).

In step 22, a user who hasn't yet voted may have the option to go to a “Flow” tab where relevant information (“buzz’, including conversations or chat about song choices) for each song is displayed in specific feeds in the “Flow” tab. The Flow tab may be a tab for selection on a user interface screen. The user may listen to or read conversations and other audio and or video information before making a vote decision. Once a decision is made by the user, in step 23, the user is restricted to a feed related to the voting selection, and the user retains the ability to return to the “Pulse” tab. In step 24, the votes are communicated to the artist. In step 25, voting progress is constantly displayed through sound and sight indicators, such as graphs, on the “Pulse” tab and is also shown on a smaller “Pulse” display in the “Flow” tab, to be monitored during discussions. In step 27, the voting period ends and the system displays the winning song. In one embodiment, the system displays rewards for the winning team. In step 28, a real-time setlist result is communicated to all the users of the system, and the song is performed. The artist keeps the setlist continually updated when he or she deviates from the prior setlist. In step 30, votes are continually received during the concert or musical event, based on the changing setlists. The artist receives the updated votes on the songs on the setlist as they change, and is able to consider the audience's real-time opinion in determining the course of the show. In step 32, users of the winning song, or users that reach participation milestones, will be awarded prizes such as tour memorabilia from sponsors such as the venue or I HEART RADIO, brands such as PEPSI®, CITI™, COCA-COLA®, or even artists. User involvement will be tracked and accumulated, and greater participation is rewarded with more exclusive prizes/awards.

A user's accumulated rewards may lead to tickets (similar to “frequent flyer” miles) or other bonuses, which would allow people, part of an associated community, to avoid the frenzy and frustration of digital ticket scalping by essentially reserving ticket options for a period of time, for users with accumulated rewards, before releasing them to the general public. This could provide incentive for users to select a certain music streaming service over another if that service has a direct pipeline to live music opportunities.

The benefits to the artist and the audience include: i) the artist's creation of an experience that is unique, memorable and tailored to the audience, and ii) the ability of the artist to gain insight into the audience's reaction throughout the course of the song. The audience also has the ability to react in real time throughout the performance of the winning song with emojis, app-specific reaction phrases and approved 3^{rd} party GIF images. Artists would have the ability to upload their own personalized emojis and reaction phrases. Examples of reaction phrases are #classic, #newhit or #myjam, or for musician specific reaction phrases, Beyonce as #BeyHiveBeat, and for Taylor Swift, #TaylorTune.

The appearance of the present system may be similar to existing systems known by workers in the art. For instance, the system may have a background similar to iTunes™ Visualizer™ and Guitar Hero™ that is displayed concurrently with “FlowFeed” along with emojis, reaction phrases, graphics interchange format (gif) items, etc. which showing up on a display similar to Periscope's Hearts™ or Facebook™ Live's video reactions that appear, float, and disappear.

In the “Flow” tab, each song has a feed which displays comments, emojis, reaction phrases, and gif images surrounding each song. When voting opens, voters will have the option to see the feed for each song before making a decision. There is a time limit to place a vote, and once a user has voted, the voter is locked into that feed and cannot view others. Optionally, the user may see a mini version of the “Pulse” monitor at the top of the “Flow” screen. The user may tap the mini-version to switch to a more detailed “Pulse” tab. Once votes are cast and the results are in, users will be taken to the feed of the winning song and have the chance to add to the “buzz” throughout the performance.

In one embodiment, there is an “Awards” tab, wherein voters of the winning song are offered prizes such as coupons on tour/concert memorabilia, discounts to future tickets or live events, or other offerings from commercial partners. The system's tracking of user usage history allows a user the possibility to accrue enough winnings or participation badges to be offered exclusive awards. Essentially, the more people vote or win, the greater the live concert-oriented awards and brand prizes there are that may be offered in the awards tab. This may provide the primary mechanism for brands, sponsors, and artists to advertise their offerings.

When the user is attending a live music event, the artist(s) playing the event decides whether to allow fans to vote on a whole setlist, a few songs on the setlist, or one song. The artist may communicate a sample setlist in advance through the system, and the setlist may be updated as the artist plays. Users attending the concert will have the opportunity to vote on what they would like to hear. Votes are tracked in real-time and displayed to the user through a dynamic, engaging, and intuitively visual showing the of votes for each song or setlist. The song or setlist with the most votes would be played by the artist at the concert.

In one embodiment, the background of the “Pulse” tab is similar to a heart monitor screen. It will start off black at the beginning of the voting phase and progress to blue, green, yellow, orange, until the voting period expires at red. Each color will be associated with a pulse sound where the pulse increases in rapidity, optionally with heart monitor sounds, until the red phase. A timed countdown begins in the red phase and once it reaches zero, a flatline sounds, the voting period ends, and a song is declared the winner.

The screen will scroll sideways. Each song will have it's own pulse that reflects the number of votes. However, all of the pulses will be on the same monitor screen so that people can view, in real time, which song is winning.

Using the system, artists may offer a more immersive concert experience to fans by allowing them to share in creating the music experience. For example, artists may tailor the selections for different audiences allowing for a stronger, more personal connection in the concert. For example, songs that are popular to a New York audience may not be popular to a London audience. Most artists already recognize this fact and modify their setlists appropriately in advance to reflect the preferences of their audience. This app would allow the artist to acknowledge this in a very tangible way, in real time, as the fans are experiencing the music.

Fans are already used to customizing their own music experience through apps like Pandora™, Spotify™. The embodiments disclosed herein permit similar customization one step further into the realm of live music.

The benefits of the voting systems is that it is real-time and delivers an immediate, tangible result. Further, the system gives value to each party involved in a live concert. The artist has the opportunity to mold a memorable, tailored experience for their fans that will generate buzz and increase fan loyalty. The fan has an unprecedented experience that is immersive, personalized, and rewarding. Immersive in its tracking of real-time sentiment and community-oriented social interaction; personalized in its delivery of a responsive live, concert experience; and rewarding in the prizes that come from participation. Sponsors and Brands will be able to show their connection and collaboration with the fans and artists, which will have a positive effect on brand awareness, brand loyalty, and brand value.

The voting system may be implemented in connection a with a number of users providing input through user interfaces of devices such as computers (including personal computers, computer tablets, etc.), and mobile phones (including smart phones). These devices may be connected to the voting system through wired and wireless communication systems/connections. Voting information, user logon information, and user preference information may be stored as data in one or more memories which the voting system may access.

### EXAMPLES

In one embodiment, Beyonce announces a new world tour. Her first stop is her hometown of Houston, Tex. Knowing this audience will want to hear some of her earliest hits, her team with local knowledge selects a few songs for the audience to vote on. During the concert, Beyonce announces that she's going to let the audience vote on the next song that she'll perform. Voting is opened up on the system for a certain amount of time and real-time results are displayed. Voters of the winning song or voters who have achieved a threshold of participation get a notification that they have received an award from the concert sponsor that entitles them to a discount on Beyonce tour memorabilia.

In a further example, Taylor Swift has a concert in Paris and Tokyo. Her team uploads two different mini-setlists customized for the Paris fans to vote on ahead of time. Whichever wins, she'll perform. Her team also does this for the Tokyo audience but the setlists are different because they're tailored to reflect the popular songs in Tokyo. Voters who choose the winning setlists or who have reached a participation threshold are informed through the Award tab notifications that they will receive a discount on beverages and food once they arrive at the concert.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

1. A non-transitory, computer-readable product for providing an in-concert music voting system, comprising code executable by a processor for causing the processor to allow a user to input, into an in-concert music voting, information on music preferences;
allow a user to scan through a playlist and vote concerning musical selections, the musical selections being matched against music preferences for a user;
allow the user to share information with one or more other users with similar preferences once a match is made; and
allow a user to vote on a playlist selection and share the playlists selection with the other users.

2. The non-transitory, computer-readable product of claim 1, wherein the code is further able to cause the processor to determine user input selections in connection with the user swiping a user interface screen.

3. The non-transitory, computer-readable product of claim 2 wherein the user swipes left to vote for a selection, and swipes right to vote against the selection.

4. The non-transitory, computer-readable product of claim 1 wherein the processor causes musical selections to be matched against music preferences for a user;
and wherein the processor permits the user to share information with one or more other users with similar preferences once a match is made.

5. The non-transitory, computer-readable product of claim 1 including code for further causing a processor to assign a tag to the user profile so that the user may share information system with other users connected to the music voting system.

6. The non-transitory, computer-readable product of claim 1, including code further causing a processor to permit parties to advertise and push ads to specific target audiences.

7. An in-concert music voting system for determining a setlist for performance by a performer comprising:
a. means to receive upload information including a plurality of performer song selections;
b. a waiting room for which a user is permitted to log in and wait to vote;
c. means to tabulate user votes on setlist selections;
d. means to present the user with interim voting results;
e. means to communicate user votes to the performer; and
f. means to notify the user of voting results.

8. An in-concert music voting system as recited in claim 7, further comprising means to communicate a setlist to the user.

9. An in-concert music voting system as recited in claim 7, further comprising means to provide advertisements to users based on user preference information.

10. An in-concert music voting system as recited in claim 7 further comprising means to allow a user to share information with one or more other users.

11. An in-concert music voting system as recited in claim 7 further comprising means to allow musical selections to be matched against music preferences for a user; and means to allow the user to share information with one or more other users with similar preferences once a match is made.

12. An in-concert music voting system as recited in claim 9, further comprising means to electronically provide advertisements to users based on demographic information in addition to user preference information.

13. An in-concert music voting system as recited in claim 7 further comprising means to provide prize notifications to users in connection with determining voting results.

14. An interactive method for determining a musical performance setlist for a performer comprising:
receiving login information from users;
setting a voting time interval;
electronically receiving votes, pertaining to a selection for a musical performance setlist, from users;
tallying votes received from users for the musical performance setlist selection;
determining, from the tallied user votes, the selection to be included in musical performance setlist;
electronically communicating, to the performer, the selection to be included in musical performance setlist.

15. An interactive method as recited in claim 14, further comprising:
electronically sending prize notifications to selected users in connection with determining tallied user votes.

16. An interactive method as recited in claim 14, further comprising:
electronically presenting users with interim voting results in connection with tallying votes received from users for the setlist.

17. An interactive method as recited in claim 14, further comprising
determining advertisements to send to users based on preferences indicated by user profile information.

18. An interactive method as recited in claim 17, further comprising
determining advertisements to send to user based on demographic data in addition to the preferences indicated by user profile information.

19. An interactive method as recited in claim 14, further comprising;
electronically providing users a playlist of musical selections for which a musical performance setlist may be constructed.

20. An interactive method as recited in claim 14, further comprising:
matching user musical selections against music preferences for a user and allowing the user to share information with one or more other users with similar preferences once a match is made.
